(19) United States
(12) Patent Application Publication
(10) Pub. No.: US 2008/0005515 A1
(43) Pub. Date: Jan. 3, 2008

(54) Plant information processing system

(75) Inventors: Naoyuki Okita, Tokyo (JP); Susumu Okuno, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 11/798,220

(22) Filed: May 11, 2007

(30) Foreign Application Priority Data
May 29, 2006 (JP) 2006-147782

(51) Int. Cl. G06F 12/14

(52) U.S. Cl. 711/163

(57) ABSTRACT

There is provided a plant information processing system capable of easily gaining access to the latest data block on each of field apparatuses without the need for an onerous task. A user-defined object designating means accepts user's access to the respective data blocks as the designation of the respective user-defined objects, and an access means acquires the physical objects corresponding to the respective user-defined objects as designated in response to acceptance of the access by the user-defined object designating means by use of the correlating means, and using the physical objects as acquired to thereby gain access to the respective data blocks corresponding thereto.

### FIELD OF THE INVENTION

The invention relates to a plant information processing system for handling data blocks on respective field apparatuses disposed inside a plant.

### BACKGROUND OF THE INVENTION

There has been known a plant information processing system for providing a user with data blocks on respective field apparatuses, as operational information. FIG. 4 is a block diagram showing a sample of a configuration of a conventional plant information processing system. As shown in FIG. 4, an information server 9 is a server for utilizing an object-oriented database, and comprises a memory 91 for accumulating data blocks on respective field apparatuses 1, a data acquisition unit 92, and an access interface 93.

As shown in FIG. 5, the operational information is represented by objects such as “tank”, “tank water level”, and so forth, and references for binding the objects with each other (for example, reference 52). The objects each express an element of the operational information, and correspond to the respective data blocks on the field apparatuses 1, 1, . . . . The references each show linkage between the objects.

The information server 9 collects the respective data blocks on the field apparatuses 1, 1, . . . from field controllers 2, 2, . . . respectively, via the data acquisition unit 92, in a given cycle, thereby storing the respective data blocks in the memory 91.

The user can gain access to the respective data blocks on the field apparatuses 1, 1, . . . by use of respective terminal units 6. The user designates the object as the element of the operational information, and requests for access to the data block corresponding thereto. In the case where the access interface 93 receives a request for the access to the data block from the terminal unit 6, the access interface 93 sends the data block stored in the memory 91 back to the terminal unit 6.

In JP 2002-41139 A, there is described an integrated managing system for holding field information acquired from field apparatuses in a database so as to be managed.

With the plant information processing system shown in FIG. 4, the respective data blocks on the field apparatuses 1, 1, . . . are stored in both the respective field controllers 2, 2, . . . , and the memory 91. The respective data blocks on the field apparatuses 1, 1, . . . , necessary for plant operation, undergo a sequential change, and values of the data blocks are managed in real time by the respective field controllers 2, 2, . . . . However, there arises a problem that the values of the data blocks in the memory 91 match values of actual data blocks only at a point in time when the data blocks are collected, and discrepancy occurs between both the values at any other timing. Further, the memory 91 is required to have a huge memory capacity in order to store massive data blocks on the field apparatuses 1, 1, . . . .

Further, with user's operation, there exist a plurality of operational points of view, so that the operational information will become complex and pluralistic in structure, and a user is compelled to carry out an onerous task when constructing a pluralistic structure from the outset. Further, with the conventional system, it is necessary for the user to designate the objects arranged in the form of the pluralistic structure as the operational information, and to request for access to the respective data blocks on the field apparatuses 1, 1, . . . , so that there is the need for constructing the operational information so as to be in the pluralistic structure with reference to all the data blocks that the user wishes to make access to. This will accordingly raise a problem that even as for the objects that are originally not required to be arranged in the form of the pluralistic structure as the operational information, the user is forced to carry out an onerous task.

### SUMMARY OF THE INVENTION

It is therefore an object of the invention to provide a plant information processing system capable of easily gaining access to the latest data block on each of field apparatuses without the need for an onerous task.

In accordance with one aspect of the invention, there is provided a plant information processing system for handling data blocks on respective field apparatuses disposed inside a plant, said system comprising a domain storage unit for storing a user-defined domain that is defined by a user as a domain for expressing operational information, a correlating means for correlating a user-defined object that is an element of the user-defined domain stored in the domain storage unit with any of physical objects identifying respective data blocks on the field apparatuses, a user-defined object designating means for accepting user's access to the respective data blocks as the designation of the respective user-defined objects, and an access means for acquiring the physical objects corresponding to the respective user-defined objects as designated in response to acceptance of the access by the user-defined object designating means by use of the correlating means, and using the physical objects as acquired to thereby gain access to the respective data blocks corresponding thereto.

With the plant information processing system, since the physical objects corresponding to the respective user-defined objects as designated are acquired in response to the acceptance of the access by the user-defined object designating means, and by use of the respective physical objects as acquired, the access is made to the respective data blocks corresponding thereto, it is always possible to gain access to the latest data.

The plant information processing system according to the invention may further comprise an address storing means for storing addresses of the respective physical objects, wherein the access means acquires the address of any of the physical objects from the address storing means, and access is gained to the data block corresponding thereto by use of the address as acquired.

Further, the plant information processing system according to the invention may further comprise a domain setting acceptance means for accepting setting of the user-defined domain, and storing the same in the domain storage unit.

Still further, the plant information processing system according to the invention may further comprise a physical object designating means for accepting the user's access to the respective data blocks on the field apparatuses as the designation of the physical object, wherein the access means makes use of the physical object as designated in response to acceptance of the user's access by the physical object designating means, thereby gaining access to the data block corresponding thereto.

With the plant information processing system according to the invention, since the physical object corresponding to the user-defined object as designated in response to the acceptance of the access by the user-defined object designating means is acquired by use of the correlating means, and by use of the physical object as acquired, the access is gained to the data block corresponding thereto, it is always possible to gain the access to the latest data.

### BRIEF DESCRIPTION OF THE DRAWINGS

FIG. 1 is a block diagram showing a configuration of a plant information processing system according to an embodiment of the invention;

FIG. 2 is a view showing concepts of a physical domain, and a user-defined domain;

FIG. 3 is a flow chart showing operation of the plant information processing system according to the embodiment in the case where a request for access to operational information is made from a terminal unit;

FIG. 4 is a block diagram showing an example of a configuration of a conventional plant information processing system; and

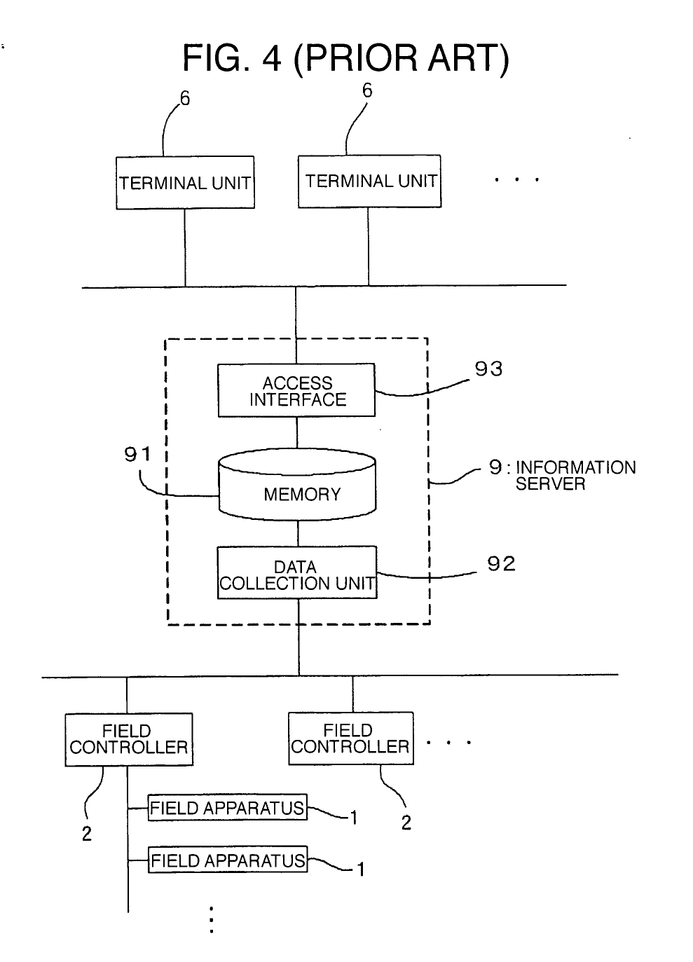

FIG. 5 is view showing a structure of the operational information.

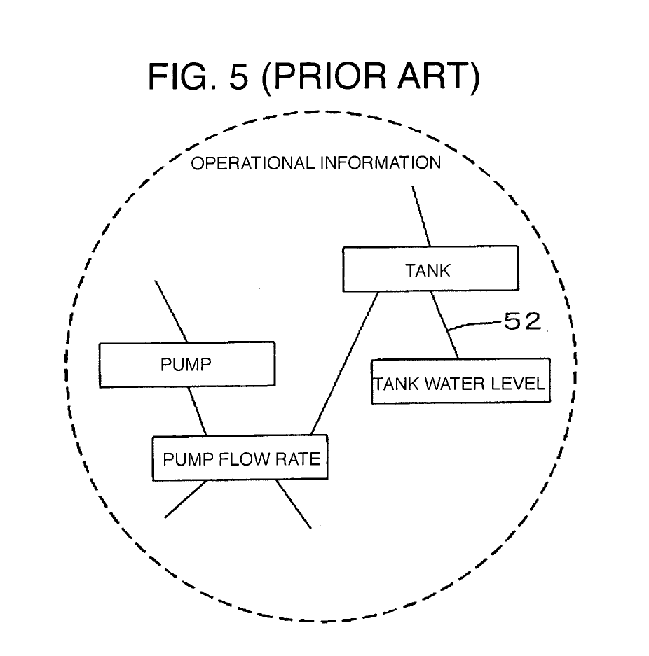

### BEST MODE FOR CARRYING OUT THE INVENTION

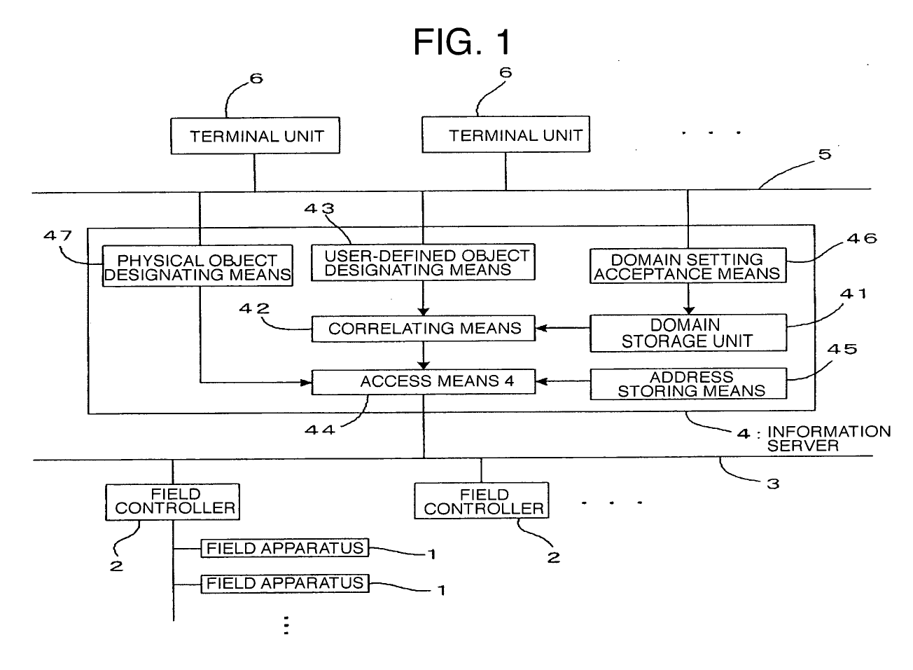

An embodiment of a plant information processing system according to the invention is described hereinafter with reference to FIGS. 1 to 3.

FIG. 1 is a block diagram showing a configuration of the plant information processing system according to the embodiment of the invention.

As shown in FIG. 1, the plant information processing system according to the present embodiment is provided with field controllers 2, 2, . . . for controlling field apparatuses 1, 1, . . . , disposed in a plant, respectively, an information server 4 connected to the respective field controllers 2, 2, . . . via a control bus 3, and terminal units 6, 6, . . . connected to the information server 4, respectively, via an information bus 5.

With the plant information processing system according to the present embodiment, various operational information is delivered to the respective terminal units 6, 6, . . . in response to respective requests from the terminal units 6, 6, . . . . In this case, the operational information refers to respective data blocks (parameter values) on the field apparatuses 1, 1, . . . as structured from a user's operational point of view. The respective data blocks on the field apparatuses 1, 1, . . . can be structured from the viewpoint of, for example, a facility configuration necessary for plant management, or a fabrication process necessary for fabrication of a specific product. As described later in the present description, the information server 4 manages the respective data blocks on the field apparatuses 1, 1, . . . , as objects by utilizing an object-oriented database.

As shown in FIG. 1, the information server 4 comprises a domain storage unit 41 for storing a user-defined domain that is defined by a user as a domain for expressing the operational information, a correlating means 42 for correlating a user-defined object that is an element of the user-defined domain stored in the domain storage unit 41 with any of physical objects identifying the respective data blocks on the field apparatuses 1, 1, . . . , a user-defined object designating means 43 for accepting user's access to the respective data blocks as the designation of the respective user-defined objects, an access means 44 for acquiring the physical objects corresponding to the respective user-defined objects as designated in response to acceptance of the access by the user-defined object designating means 43 by use of the correlating means 42, and using the physical objects as acquired to thereby gain access to the respective data blocks corresponding thereto, an address storing means 45 for storing respective addresses of the physical objects, a domain setting acceptance means 46 for accepting setting of the user-defined domain, and storing the same in the domain storage unit 41, and an a physical object designating means 47 for accepting the user's access to the respective data blocks on the field apparatuses 1, 1, . . . , as the designation of the physical object.

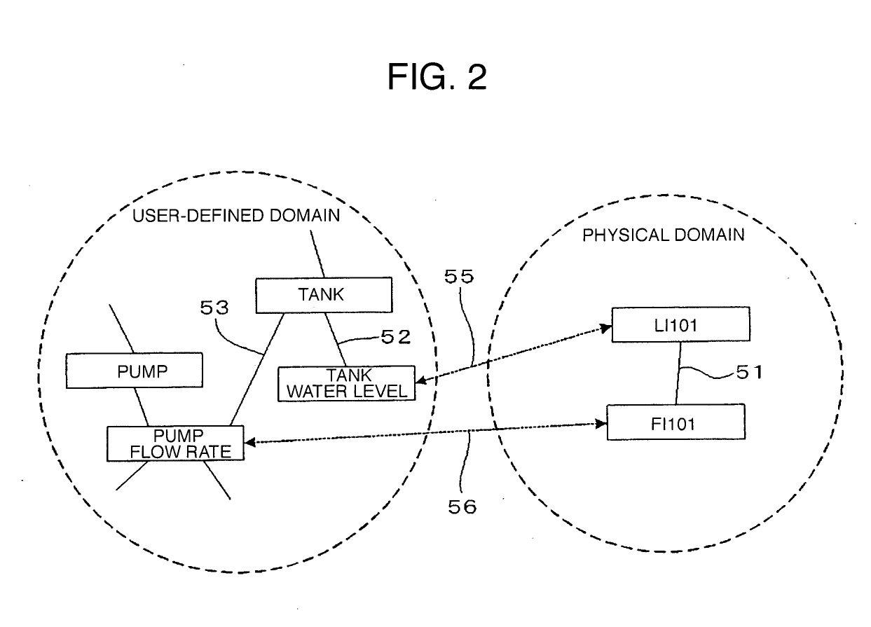

FIG. 2 is a view showing concepts of a physical domain, and the user-defined domain.

In FIG. 2, the physical domain expresses a map of the respective data blocks on the field apparatuses 1, 1, . . . managed by the field controller 2, and is stored in the address storing means 45. The physical domain exists so as to correspond to each of the field controllers 2, 2 . . . . The respective data blocks on the field apparatuses 1, 1, . . . are expressed as objects (the physical objects). In FIG. 2, object “L1101” and object “F1101” are each shown as the physical object. Those objects each have only a pointer to each of the data blocks on the field apparatuses 1, 1, . . . managed by the respective field controllers 2, but do not have a value. The pointer indicates addresses of the individual physical objects (the respective data blocks on the field apparatuses 1, 1, . . . ).

The physical domain has a structure expressed by means of references each specifying a relation between the objects. In FIG. 2, there is shown a reference 51 linking the object “L1101” with the object “F1101”.

The physical domain is described in a memory of each of the field controllers 2, and if access is made to each of the field controllers 2, this will enable the objects and references, in the physical domain corresponding thereto, to be constructed. The physical domain does not require engineering by the user, and is predetermined upon construction of the system.

The pointers held by the respective objects of the physical domain can be acquired by making access to the address storing means 45.

In FIG. 2, the user-defined domain expresses the operational information. The user-defined domain exists by the user's operational point of view, and can be arbitrarily defined by the user. The elements of the operational information are expressed as the objects (the user-defined objects), respectively. In FIG. 2, an object “tank”, object “tank water level”, object “pump”, and object “pump flow rate” are each shown as the user-defined object. A structure of the user-defined domain, namely, a structure of the operational information is expressed by means of references each specifying a relation between the respective objects. In FIG. 2, there are shown a reference 52 linking the object “tank” with the object “tank water level”, a reference 53 linking the object “tank” with the object “pump flow rate”, and so forth.

The setting of the user-defined domain is accepted by the domain setting acceptance means 46 according to the user's manipulation against the respective terminal units 6, and the user-defined domain as set is stored in the domain storage unit 41. The user can freely construct the references and objects in the user-defined domain through the intermediary of the domain setting acceptance means 46.

As shown in FIG. 2, the user-defined objects indicating the respective elements of the operational information are joined with the physical objects, corresponding thereto, by binding. In FIG. 2, for example, the object “tank water level”, and the object “L1101” are joined together by a binding 55, and the object “pump flow rate”, and the object ” F1101” are joined together by a binding 56. Those objects joined together by the bindings are each treated as an identical object. Such correlation thereof through the bindings is recognized by access made to the correlating means 42. Setting of the binding can be executed through the user's operation via the respective terminal units 6.

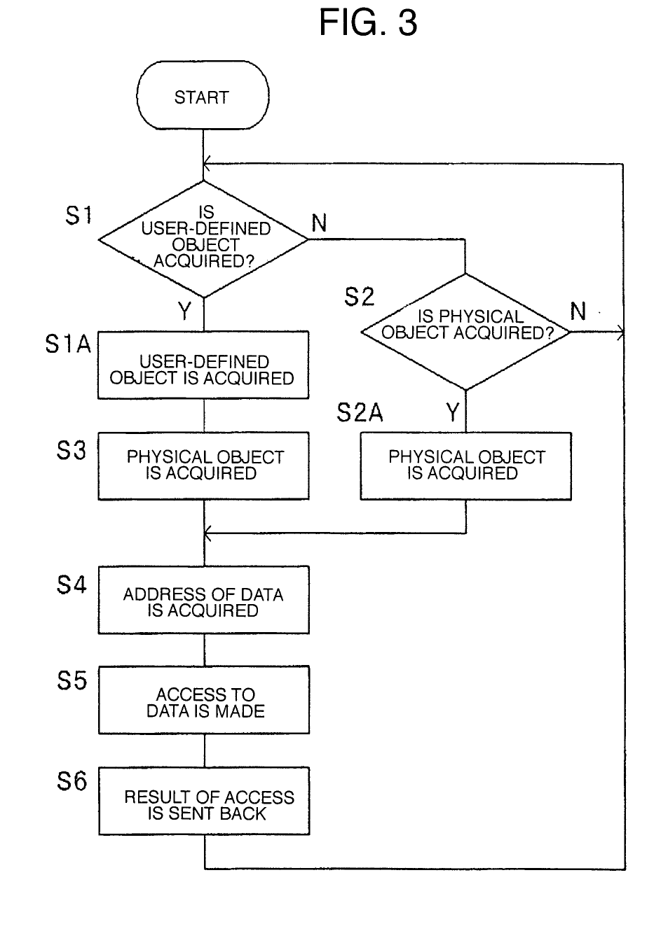

FIG. 3 is a flow chart showing the operation of the plant information processing system according to the present embodiment in the case where a request for access to the operational information is made from the terminal unit 6.

In step S1 of FIG. 3, determination is made whether or not the user-defined object designating means 43 has accepted the user's access. In the case of making access to the operational information, the user executes a predetermined manipulation against the terminal unit 6, and is thereby able to cause the user-defined object designating means 43 to designate the user-defined object corresponding to the user's access. If the user-defined object designating means 43 has accepted the designation of the user-defined object from the terminal unit 6, the determination in step S1 is Yes.

If the determination in step S1 is Yes, the operation proceeds to step S1A while if the determination in step S1 is No, the operation proceeds to step S2.

In step S1A, the user-defined object as designated by the user-defined object designating means 43 (step S1) is acquired, and the operation proceeds to step S3.

In step S3, access is made to the correlating means 42, thereby acquiring a physical object correlated with the user-defined object as designated by the user-defined object designating means 43 (step S1). If, for example, the object “tank water level” is designated by the user-defined object designating means 43, the object “L1101” (FIG. 2) joined with the object “tank water level” by the binding 55 is acquired, whereupon the operation proceeds to step S4.

Meanwhile, in step S2, determination is made whether or not the physical object designating means 47 has accepted the user's access. In the case of gaining access to the operational information, the user executes a predetermined manipulation against the terminal unit 6, and is thereby able to cause the physical object designating means 47 to designate the physical object corresponding to the user's access. If the physical object designating means 47 has accepted the designation of the physical object from the terminal unit 6, determination in step S2 is Yes.

If the determination in step S2 is Yes, the operation proceeds to step S2A, and if the determination in step S2 is No, the operation reverts to step S1. In step S2A, the physical object as designated by the physical object designating means 47 (step S2) is acquired, and the operation proceeds to step S4.

Then, in step S4, access is made to the address storing means 45, and a pointer to the physical object acquired in step S3, or step S2A is thereby obtained.

Subsequently, in step S5, access is made to the pointer acquired in step S4, and a value of a data block on the field apparatus 1 corresponding to the physical object is thereby acquired from a relevant field controller 2. Then, in step S6, the value of the data block acquired from the field controller 2 is sent from the information server 4 back to the terminal unit 6, whereupon the operation reverts to step S1.

Thus, with the plant information processing system according to the present embodiment, access is made to the field controller 2 in every response to a request from the terminal unit 6. Accordingly, the data block delivered to the terminal unit 6 always matches an actual data block held by the field apparatus 1.

Further, with the plant information processing system according to the present embodiment, the information server 4 for accepting the user's request is separated from the field controller 2 for storing the value of the data block on the field apparatus 1, and the information server 4 stores only the pointers, but does not store the values of the data blocks. In consequence, a memory capacity of the information server 4 is never bloated.

With the plant information processing system according to the present embodiment, the user-defined domain coexists with and the physical domain. For this reason, the system can provide the user with both the operational information arbitrarily defined by the user, and the map of the data blocks managed by the field controllers 2, 2, . . . , respectively. The user is able to designate the user-defined object to thereby gain access to the data block on the field apparatus 1, and is also able to designate the physical object to thereby gain access to the relevant data block. Further, through separation of the user-defined domains established from a plurality of operational points of view, respectively, it becomes possible to provide operational support to individual users whose operations differ in content from each other. Furthermore, as to the data blocks that are not required to be structured according to the operational point of view, it need only be sufficient to provide the map of the data blocks in the physical domain, so that man-hour for preparing the operational information can be reduced.

With the plant information processing system according to the present embodiment, the operational information is constructed by correlating the user-defined domain with the physical domain by means of the binding. For this reason, the user is able to freely construct the user-defined domain on the basis of the physical domain. Further, the plurality of the operational points of view are expressed in the form of the respective user-defined domains, and the individual user-defined domains are separated from each other, so that the operational information can be prepared with ease. Further, in the case of constructing the user-defined domain, it is also possible to set a new user-defined domain on the basis of any other user-defined domain that has already been established.

Further, it is also possible to integrate time series data blocks by utilizing the binding. For example, present values such as a process value of the field apparatus, and so forth, historical data blocks, and predicted data blocks can be integrated together with respective bindings from an identical object, thereby enabling those data blocks to be related with each other as the time series data blocks.

Still further, by adding an attribute to the respective references, it is possible to express the significance of relation between the objects. For example, date, the number of times, and so forth can be added as the attribute.

Yet further, if a plant hierarchy is formed on the basis of the user-defined domain, this will enable hierarchies of facilities to be integrated.

As described in the foregoing, with the plant information processing system according to the present embodiment, the physical object correlated with the user-defined object as designated is acquired by use of the correlating means in response to the acceptance of the user's access, by the user-defined object designating means, and by use of the physical object as acquired, access is gained to the data block corresponding thereto, so that it is always possible to gains access to the latest data block. Further, by causing the user-defined domain to be compatible with the physical domain, the system can provide the user with both the operational information arbitrarily defined by the user, and the map of the data blocks managed by the respective field controllers.

Further, it is to be understood that the invention is not limited in its application to the embodiment described hereinbefore. The invention can be widely applied to a plant information processing system for handling data blocks on respective field apparatuses disposed inside a plant.

1. A plant information processing system for handling data blocks on respective field apparatuses disposed inside a plant, said system comprising:
a domain storage unit for storing a user-defined domain that is defined by a user as a domain for expressing operational information;
a correlating means for correlating a user-defined object that is an element of the user-defined domain stored in the domain storage unit with any of physical objects identifying respective data blocks on the field apparatuses;
a user-defined object designating means for accepting user's access to the respective data blocks as the designation of the respective user-defined objects; and
an access means for acquiring the physical objects corresponding to the respective user-defined objects as designated in response to acceptance of the access by the user-defined object designating means by use of the correlating means, and using the physical objects as acquired to thereby gain access to the respective data blocks corresponding thereto.

2. The plant information processing system according to claim 1 further comprising an address storing means for storing addresses of the respective physical objects, wherein the access means acquires the address of any of the physical objects from the address storing means, and access is gained to the data block corresponding thereto by use of the address as acquired.

3. The plant information processing system according to claim 1 or 2 further comprising a domain setting acceptance means for accepting setting of the user-defined domain, and storing the same in the domain storage unit.

4. The plant information processing system according to claim 1 or 2 further comprising a physical object designating means for accepting the user's access to the respective data blocks on the field apparatuses as the designation of the physical object, wherein the access means makes use of the physical object as designated in response to acceptance of the user's access by the physical object designating means, thereby gaining access to the data block corresponding thereto.

5. The plant information processing system according to claim 3 further comprising a physical object designating means for accepting the user's access to the respective data blocks on the field apparatuses as the designation of the physical object, wherein the access means makes use of the physical object as designated in response to acceptance of the user's access by the physical object designating means, thereby gaining access to the data block corresponding thereto.
